(19) United States
(12) Patent Application Publication
(10) Pub. No.: US 2025/0304110 A1
(43) Pub. Date: Oct. 2, 2025

(54) TRAJECTORY PLANNING FOR AUTONOMOUS VEHICLE WITH PARTICLE SWARM OPTIMIZATION

(71) Applicant: Honda Motor Co., Ltd., Tokyo (JP)

(72) Inventors: Lin SONG, Champaign, IL (US); David F. ISELE, Sunnyvale, CA (US); Sangjae BAE, San Jose, CA (US)

(21) Appl. No.: 18/617,570

(22) Filed: Mar. 26, 2024

(51) Int. Cl. B60W 60/00; B60W 50/00; G06N 3/0475

(52) U.S. Cl. CPC B60W 60/0011; B60W 50/0097; B60W 60/0015; G06N 3/0475; B60W 2554/4045; B60W 2554/80

(57) ABSTRACT

A method vehicle control system for generating and controlling a trajectory of an autonomous vehicle uses a trained neural network model to estimate future positions of other vehicles in an environment surrounding the autonomous vehicle, and a particle swarm optimization algorithm to generate a dynamically feasible trajectory based on an initial trajectory and the estimated future positions of the other vehicles. The method and system fits a polynomial curve to the dynamically feasible trajectory, and converts the polynomial curve into reference waypoints to generate the trajectory based on the reference waypoints. The vehicle is then controlled to autonomously drive using the generated trajectory.

### BACKGROUND

Vehicles driven in open environments, such as roadways, may now benefit from autonomous driving systems which may drive the vehicle with no user input. Generally, while operating on roadways, the autonomous driving systems utilize data acquired about the vehicle itself as well as the environment in which the vehicle is operating, including potential obstacles in a roadway and other vehicles traveling on the roadway. While many techniques have been explored to best utilize the acquired data, an accuracy-efficiency tradeoff may limit the utilization of certain combinations of techniques, particularly for techniques that require real-time, interactive calculation and estimation.

### BRIEF DESCRIPTION

According to one aspect, a method for generating and controlling a trajectory of an autonomous vehicle includes generating an initial trajectory of the autonomous vehicle, estimating future positions of other vehicles in an environment surrounding the autonomous vehicle using a trained neural network model, generating a dynamically feasible trajectory based on the initial trajectory and the estimated future positions of the other vehicles using a particle swarm optimization algorithm, fitting a polynomial curve to the dynamically feasible trajectory, and converting the polynomial curve into reference waypoints and generating the trajectory based on the reference waypoints.

According to another aspect, a vehicle control system is provided in a vehicle and includes a vehicle electronic control unit in communication with a vehicle sensor system and a vehicle actuator system. The electronic control unit is programmed to generate an initial trajectory of the vehicle for autonomously driving the vehicle, estimate, based on received sensor data from the vehicle sensor system, future positions of other vehicles in an environment surrounding the vehicle using a trained neural network model, generate a dynamically feasible trajectory based on the initial trajectory and the estimated future positions of the other vehicles using a particle swarm optimization algorithm, fitting a polynomial curve to the dynamically feasible trajectory, converting the polynomial curve into reference waypoints and generating the trajectory based on the reference waypoints, and transmit control signals to the vehicle actuator system to cause the vehicle actuator system to autonomously control the vehicle to travel according to the trajectory.

According to another aspect, a vehicle capable of autonomous driving includes a vehicle sensor system, a vehicle actuator system, and a vehicle electronic control unit in communication with the vehicle sensor system and the vehicle actuator system. The electronic control unit being programmed to generate an initial trajectory of the vehicle for autonomously driving the vehicle, estimate, based on received sensor data from the vehicle sensor system, future positions of other vehicles in an environment surrounding the vehicle using a trained neural network model, generate a dynamically feasible trajectory based on the initial trajectory and the estimated future positions of the other vehicles using a particle swarm optimization algorithm, fit a polynomial curve to the dynamically feasible trajectory, convert the polynomial curve into reference waypoints and generating the trajectory based on the reference waypoints, and transmit control signals to the vehicle actuator system to cause the vehicle actuator system to control the vehicle to travel according to the trajectory. The vehicle actuator system is configured to drive the vehicle based on the control signals transmitted by the electronic control unit.

### BRIEF DESCRIPTION OF THE DRAWINGS

FIG. 1 is a schematic illustration of a vehicle including a vehicle control system, a vehicle sensor system, and a vehicle actuator system.

FIG. 2 is a block schematic illustrating exemplary components of the vehicle control system, the vehicle sensor system, and the vehicle actuator system.

FIG. 3 is a block schematic illustrating exemplary components of the electronic control unit (ECU).

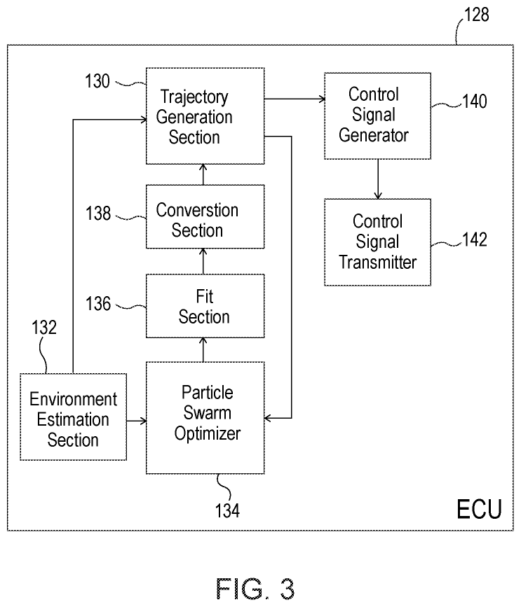

FIG. 4 is a flow chart illustrating a method for generating a trajectory of an autonomous vehicle.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory,” as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive,” as used herein, may be a magnetic disk drive, a solid state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus,” as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database,” as used herein, may refer to a table, a set of tables, and a set of data stores (e.g., disks) and/or methods for accessing and/or manipulating those data stores.

An “operable connection,” or a connection by which entities are “operably connected”, is one in which signals, physical communications, and/or logical communications may be sent and/or received. An operable connection may include a wireless interface, a physical interface, a data interface, and/or an electrical interface.

A “computer communication,” as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “vehicle,” as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

A “vehicle system,” as used herein, may be any automatic or manual systems that may be used to enhance the vehicle, and/or driving. Exemplary vehicle systems include an advanced driver assistance system, an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

The aspects discussed herein may be described and implemented in the context of non-transitory computer-readable storage medium storing computer-executable instructions. Non-transitory computer-readable storage media include computer storage media and communication media. For example, flash memory drives, digital versatile discs (DVDs), compact discs (CDs), floppy disks, and tape cassettes. Non-transitory computer-readable storage media may include volatile and non-volatile, removable and non-removable media implemented in any method or technology for storage of information such as computer readable instructions, data structures, modules, or other data.

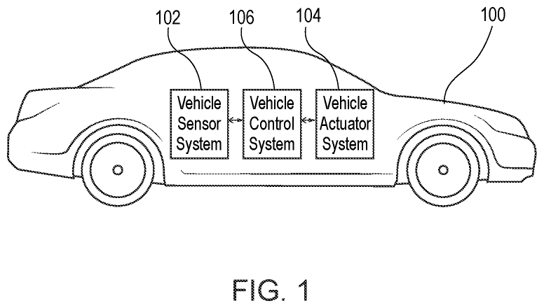

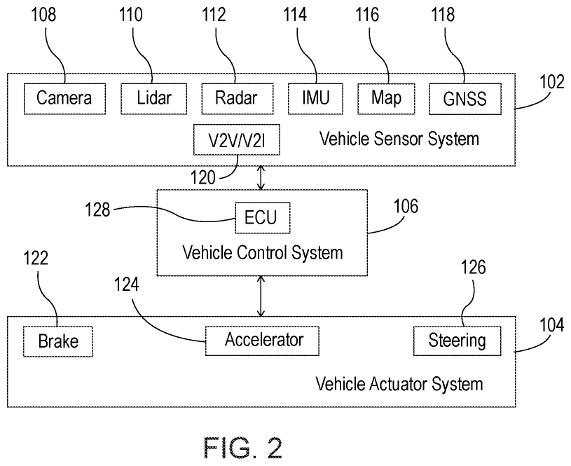

Referring to FIGS. 1 and 2 of the present application, a vehicle 100 is shown to include a vehicle sensor system 102, a vehicle actuator system 104, and a vehicle control system 106. The vehicle control system 106 has an operable connection that facilitates computer communication to and with the vehicle sensor system 102 and the vehicle actuator system 104. The vehicle control system 106 controls the vehicle sensor system 102 to retrieve environmental information (e.g., information related to an environment surrounding the vehicle), and receives the environmental information as input data from the vehicle sensor system 102. The vehicle control system 106 also receives operation information related to operating parameters of the vehicle 100 from the vehicle actuator system 104, and may operate to control the vehicle actuator system 104 autonomously, without relying on user input, or based on detected user inputs (e.g., via a steering wheel, accelerator, clutch and gear shift, etc.) As described in further detail below, the vehicle control system 106 performs processing on the environmental information received from the vehicle sensor system 102 and the operating parameters of the vehicle 100 received from the vehicle actuator system 104, as well as preset and/or user inputs, to determine control of the vehicle 100 and to control the vehicle actuator system 104 to perform the determined control of the vehicle 100. The vehicle 100 as described herein is an autonomous vehicle in which the vehicle control system 106 controls the vehicle actuator system 104 to drive the vehicle 100 with no or minimal user input.

The vehicle sensor system 102 may include any one or more sensors provided on or off the vehicle 100, which may be used to collect environmental information related to the environment in which the vehicle 100 is operating. For example, the vehicle sensor system 102 may include camera 108, a Lidar (Light Detection and Ranging) Device 110, a radar device 112, an inertial measurement unit (IMU) 114, a map database 116, a global navigation satellite system 118 (GNSS), and a vehicle-to-vehicle (V2V)/vehicle-to-infrastructure (V2I) system 120 that allows for communication with other vehicles and infrastructure support components.

The present application envisions that any and all of the components listed above as exemplary parts of the vehicle sensor system 102 may be included or omitted, in any combination. When included, the above components may be provided as a singular component or as a plurality of like components (e.g., the camera 108 may be provided as a plurality of cameras, the IMU 114 may be provided as a plurality of IMUs, etc.), situated and placed on any parts of the vehicle to facilitate the retrieval of the environmental information.

Additionally, the components of the vehicle sensor system 102 may be provided from known components configured to perform the functions known to be performed by the components. The components may be wholly embodied by devices which communicate with the vehicle control system 106, may be embodied by a device which requires processing either performed internally or by the vehicle control system 106, or may be entirely embodied by processing performed by the vehicle control system 106, e.g., based on information received by a vehicle receiver or transceiver (not shown) in communication with the vehicle control system 106. For example: the map database 116 may be stored in a memory in the vehicle control system 106; and the processing associated with the GNSS 118 and the V2V/V2I 120 may be performed by the vehicle control system 106 based on information received by the receiver or transceiver. Additionally, as will be clear with reference to the below discussion, the vehicle control system 106 performs processing on the environmental information data input from the vehicle sensor system 102 and uses the processed environmental information data to determine how to control the vehicle 100 via the vehicle actuator system 104.

The vehicle actuator system 104 includes a brake 122, an accelerator 124, and a steering 126. The brake 122 is used to stop the vehicle 100, for example by halting rotation of wheels of the vehicle 100. The accelerator 124 is used to make the vehicle 100 drive, for example, by causing drive wheel(s) of the vehicle 100 to rotate. The steering 126 is used to direct a trajectory of the vehicle 100, for example by turning wheels of the vehicle 100. To support autonomous driving, the brake 122, the accelerator 124, and the steering 126 may be controlled by the vehicle control system 106 to cause the vehicle to drive, stop, and turn. The brake 122, the accelerator 124, and the steering 126 are all known components of a vehicle and may be provided in any manner or configuration.

The vehicle control system 106 includes an electronic control unit (ECU) 128. The ECU 128 may be a vehicle ECU that controls and monitors any and all vehicle functions. The ECU 128 may be configured by one or more processors, together with a memory on which a control program is stored, so that the ECU 128 functions as described herein when the processor executes the control program. The ECU 128 may be part of the vehicle ECU or may be provided separately from the vehicle ECU via one or more processors or computers, with all or some of the functions being performed in the vehicle 100 or remote from the vehicle 100 with communication with the vehicle 100. Within the context of the instant application, the ECU 128 is configured to receive inputs from the vehicle sensor system 102 and the vehicle actuator system 104, and to control the vehicle actuator system 104 based on processing those inputs.

The ECU 128 includes a trajectory generation section 130, an environment estimation section 132, a particle swarm optimizer 134, a fit section 136, a conversion section 138, a control signal generator 140, and a control signal transmitter 142. It should be appreciated that the ECU 128 may be a fully-realized vehicle ECU that includes other computational, functional, or control components or sections, and may be configured to perform other functions related to the vehicle 100. In this description, the ECU 128 will be described with respect to its operation in facilitating autonomous driving of the vehicle 100, and as such, only those components relevant to such autonomous driving are described herein.

Briefly, the trajectory generation section 130 is configured to generate a trajectory of the vehicle 100, based on inputs from the vehicle sensor system 102, the vehicle actuator system 104, the environment estimation section 132, and the particle swarm optimizer 134 via the fit section 136 and the conversion section 138. The trajectory generated by the trajectory generation section 130 is sent to the control signal generator 140, which generates control signals to be sent to the vehicle actuator system 104 for controlling the vehicle actuator system 104 to autonomously drive the vehicle 100. The control signal transmitter 142 transmits the control signals generated by the control signal generator 140 to the vehicle actuator system 104.

The environment estimation section 132 receives inputs from the vehicle sensor system 102 and uses these inputs to estimate an environment surrounding the vehicle 100, including current and future positions of other vehicles in the environment surrounding the vehicle 100. To estimate the future positions of other vehicles in the environment surrounding the vehicle 100, the environment estimation section 132 may use a trained neural network model, such as neural network model predictive control, namely, an SGAN (Social Generative Adversarial Networks) model. The environment estimation section 132 then outputs the estimations to the trajectory generation section 130, which generates the trajectory.

The environment estimation section 132 also outputs the estimated future position of other vehicles in the environment surrounding the vehicle 100 to the particle swarm optimizer 134, which uses the estimated future position of other vehicles in the environment surrounding the vehicle 100 together with an initial trajectory generated by the trajectory generation section 130 to generate a dynamically feasible trajectory using a particle swarm optimization (PSO) algorithm. The dynamically feasible trajectory is then output to the fit section 136, which fits a polynomial curve to the dynamically feasible trajectory, and to the conversion section 138, which converts the polynomial curve fitted by the fit section 136 into reference waypoints. The reference waypoints are returned to the trajectory generation section 130 for generation of the trajectory based on the reference waypoints received from the conversion section 138.

The use of the SGAN model and PSO algorithm to generate the trajectory of the vehicle 100 by which the vehicle 100 is controlled to travel is described hereinbelow with reference to a scenario in which the vehicle 100 is driving on a roadway and is changing lanes. Changing lanes on the roadway may present significant complexity, particularly in dense traffic scenarios. The complexities may result in significant computational expense when trying to develop predictive and control models for autonomously driving a vehicle, and hence may particularly benefit from the herein-described method and system for trajectory generation and control. The use of the SGAN model and PSO algorithm described herein effectively predicts the environment surrounding the vehicle 100 and determines a control trajectory of the vehicle 100 along the generated trajectory, while sufficiently reducing computational expense.

To this end, trajectory planning and generation by the trajectory generation section 130 utilizes a bicycle model in which discrete-time kinematics are represented as:

$${x}_{k} = Δ t \cdot {v}_{k - 1} cos ( {ψ}_{k - 1} + {β}_{k - 1} ) + {x}_{k - 1} \qquad ( 1 )$$

$${y}_{k} = Δ t \cdot {v}_{k - 1} sin ( {ψ}_{k - 1} + {β}_{k - 1} ) + {y}_{k - 1} \qquad ( 2 )$$

$${ψ}_{k} = ( {v}_{k - 1} / {I}_{r} ) sin ( {β}_{k - 1} ) + {ψ}_{k - 1} \qquad ( 3 )$$

$${v}_{k} = Δ t \cdot {a}_{k - 1} + {v}_{k - 1} \qquad ( 4 )$$

$${β}_{k} = {tan}^{- 1} ( ( {I}_{r} / ( {I}_{f} + {I}_{r} ) ) tan ( {δ}_{k} ) ) \qquad ( 5 )$$

where (xₖ, yₖ) represents the Cartesian coordinate of the center of the vehicle 100 at time k, ψₖ denotes the inertial heading of the vehicle 100, vₖ is the speed of the vehicle 100, aₖ is the acceleration of the center of the vehicle 100, l_{f} and lᵣ denote the distance from the center of the vehicle 100 to front and rear axles of the vehicle 100, respectively, and βₖ is the angle of the current velocity of the center of the vehicle 100 with respect to a longitudinal axis (forward-rearward direction) of the vehicle 100. The control inputs of the bicycle model include a steering angle δₖ and an acceleration aₖ, which may be inputs communicated with the vehicle actuator system 104 and/or the vehicle sensor system 102.

The environment estimation section 132 estimates future positions of other vehicles in the environment surrounding the vehicle 100 using the SGAN model to predict vehicular behaviors. This allows the vehicle control system 106 to facilitate interaction-aware trajectory planning, in which a trained SGAN model, as a trained neural network, may efficiently generate the most probable trajectories for surrounding vehicles using positional observations derived from the vehicle sensor system 102 as inputs. The SGAN model is presented as a function ϕ(·), translating past observations into anticipated positional sequences, represented as ϕ(·):Z(k)→, \hat{Z}(k), where

$$Z ( k ) = [ \begin{matrix}{z}_{1} ( k ) & … & {z}_{{N}_{veh}} ( k ) \\ ⋮ & ⋱ & ⋮ \\ {z}_{1} ( k - {N}_{obs} + 1 ) & … & {z}_{{N}_{veh}} ( k - {N}_{obs} + 1 )\end{matrix} ] \qquad ( 6 )$$

$$\hat{Z} ( k ) = [ \begin{matrix}{\hat{z}}_{1} ( k + 1 ) & … & {\hat{z}}_{{N}_{veh}} ( k + 1 ) \\ ⋮ & ⋱ & ⋮ \\ {\hat{z}}_{1} ( k + {N}_{pred} ) & … & {\hat{z}}_{{N}_{veh}} ( k + {N}_{pred} )\end{matrix} ] \qquad ( 7 )$$

In the above, zᵢ(k)=(xᵢ(k), yᵢ(k)) denotes a tuple of position coordinates for time k, N_{obs} and N_{pred} represent the observation and prediction horizons, respectively, and Nᵥₑₕ represents the number of total vehicles.

The particle swarm optimizer 134 uses a PSO algorithm to generate a feasible trajectory based on the initial trajectory generated by the trajectory generation section 130 and the estimated future positions of the other vehicles in the environment surrounding the vehicle 100, estimated by the environment estimation section 132 using the SGAN model. The PSO algorithm imitates the social behavior of collaborative search and information exchange within swarms. The PSO algorithm has a derivative-free nature and, as such, is useful for solving nonlinear optimization problems with real-time computation capability.

In the PSO algorithm, each particle in a multi-dimensional search space represents a solution candidate to the optimization problem. Each particle may memorize its best performance from past searches. The positions pᵢ and velocities vᵢ of the particles are uniformly randomly initialized for exploration purposes. The particle velocity vᵢ is then adjusted according to the best self-cognitive experience p_{i,lb} and the best experience achieved by the entire population p_{gb}, as well as the velocity component to be preserved. The particle velocity update rule of the PSO algorithm is:

$${v}_{i , k + 1} = {wv}_{i , k} + {c}_{1} {r}_{1} ( {p}_{i , lb} - {p}_{i , k} ) + {c}_{2} {r}_{2} ( {p}_{gb} - {p}_{i , k} ) \qquad ( 8 )$$

where w is the inertia weight, c₁, c₂ are acceleration coefficients reflecting self-cognition and social influence, and random numbers r₁, r₂∈[0, 1] are used to avoid local optima in the optimization process. The random initialization of particle positions, velocities, and the stochastic adjustment of particle velocities, facilitate the efficient search for feasible solutions. Large inertia weight w favors the global search of an optimal solution, while small inertia weight w improves the local search capacity. A reduced inertia weight may allow for faster convergence. The global-best particles are replaced by the local-best particles when a lower cost value is achieved from any agent within the swarm. The updated particle position is then computed using the updated particle velocity according to

$${p}_{i , k} = {p}_{i , k - 1} + {v}_{i , k} . \qquad ( 9 )$$

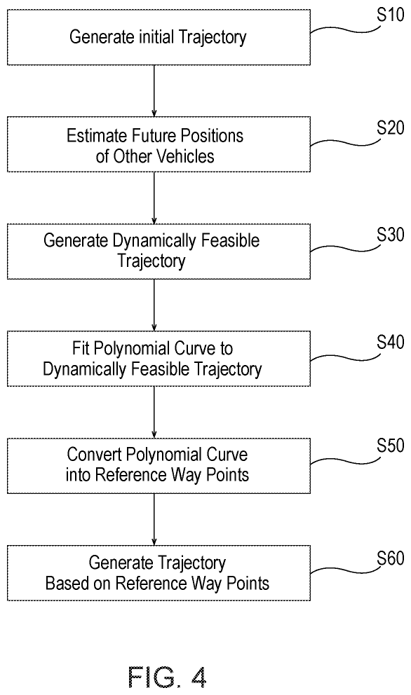

Continuing from the above, a method for generating a trajectory of an autonomous vehicle, for example when the autonomous vehicle, as the vehicle 100, is merging into a different lane of traffic, is shown in the flow chart of FIG. 4. Therein, the method commences with the generation of an initial trajectory (S10) by the trajectory generation section 130. The generation of the initial trajectory may be made using a motion/path planner to achieve reference waypoints, based on inputs from the vehicle sensor system 102, the vehicle actuator system 104, and the environment estimation section 132. Specifically, the trajectory generation section 130 uses, as inputs, a target state of the vehicle 100 (x*, y*, ψ*), a current state of the ego vehicle (x₀, y₀, ψ₀), and observed positions of other vehicles [(z_{i,1}, . . . , z_{i,Nveh})]_{i=1:Nobs}. The initial trajectory is represented by reference waypoints z̅ᵢ₀=[(x̅ᵢ, y̅ᵢ, v̅ᵢ)]_{i=1:N}. The motion/path planner, as used herein, may be configured of any combination of hardware and software, implemented by the ECU 128 and the trajectory generation section 130, and may take the form, e.g., of a convention motion or path planner used in determining a trajectory of a vehicle based on preset, determined, or input waypoints and other factors related to movement of the vehicle.

The method then proceeds to estimate the future positions of the other vehicles in the environment surrounding the vehicle 100 (S20), by the environment estimation section 132 using the SGAN model discussed above. The estimated positions of the other vehicles is represented as [(z_{i,1}, . . . , z_{i,Nveh})]_{i=1:Npred}.

The method proceeds to then use the particle swarm optimizer 134 to generate the dynamically feasible trajectory (S30) using the PSO algorithm. In this regard, based on the initial trajectory, a reference acceleration and heading angle sequence are computed using the reference waypoints of the initial trajectory. Then, the PSO algorithm is used to generate the dynamically feasible trajectory [(\hat{x}ᵢ, ŷᵢ)]_{i=1:N}, as well as a refined steering angle sequence [δ*₁, . . . , δ*_{N}].

In the PSO algorithm, each particle pᵢ represents a sequence of steering angles, defined as pᵢ=[δ_{i,1}, δ_{i,2}, . . . , δ_{i,N}], where N denotes the horizon. These particles undergo propagation via vehicle kinematics to maintain the feasibility of the solution. The inputs of the PSO algorithm includes reference waypoints in the form of position and velocity profiles (i.e., (xᵢ, yᵢ, vᵢ) tuples) from the trajectory generation section 130, along with the estimated positions of other vehicles in the environment surrounding the vehicle 100, where [(z_{i,1}, . . . , z_{i,Nveh})]_{i=1:Nobs}, where zᵢ=(xᵢ, yᵢ) represents each other vehicle's position coordinates in Cartesian space and Nᵥₑₕ denotes the number of vehicles and N_{obs} indicates the observation horizon.

The PSO algorithm begins with a random initialization of particles' positions and velocities, where each particle represents a steering angle sequence for the lane-change maneuver. The range for the uniform random initialization of particle position pᵢ and velocity vᵢ may be based on information from initial reference waypoints from the initial trajectory. The velocity, steering angle sequence, and position for each of the particles is iteratively updated using equations (8) and (9). In the iterative updating, each particle retains and updates its optimal solution discovered across iterations (referred to as the ‘local-best’ solution). Moreover, the population's best solution (referred to as the ‘global-best’ solution) is updated when a superior performance is achieved. Particle velocity updates are computed based on the particle's prior velocity, its local best position p_{i,lb}, and the population's global-best position p_{gb}.

In assessing the local-best and global-best solutions, a cost value is calculated for each of the particles at each iteration using a cost function. The cost evaluation of particles proceeds in two steps. Initially, the steering angle sequence of each of the particles is propagated through the vehicle dynamics according to equations (1)-(5). This yields dynamically feasible trajectories, ensuring the generated position sequences adhere to all non-holonomic constraints. Subsequently, the cost function assesses the generated trajectory as well as the most optimal particle discovered. The cost function incorporates safety constraints as well as other parameters.

In assessing the cost value, reference waypoints (xᵢ, yᵢ, vᵢ) are extracted using the motion/path planner. Subsequently, reference control sequences, namely, acceleration aᵢ and steering angle δᵢ are computed based on the reference waypoints that have been extracted. These reference control sequences are utilized in the kinematics propagation to generate dynamically feasible trajectories, and also in evaluating the cost of particles. The cost function considers safety considerations, acceleration, and jerk regulation for enhanced driving comfort, adherence to the reference trajectory, and alignment with the lane center. Generally, the cost function is set to penalize deviations from a current trajectory, penalize deviations from a current heading, significantly penalize violations of safety metrics, reward increases in driving comfort, and reward maintenance of a lane-center position. Specifically, the cost function is represented as:

$${f}_{PSO} = {f}_{ref} + {f}_{head} + {f}_{col} + {f}_{a} + {f}_{j} + {f}_{s} + {f}_{la} . \qquad ( 10 )$$

The individual components of the cost function f_{PSO} are defined below.

f_{ref} penalizes deviations from the current/reference trajectory in the form of f_{ref}=w_{ref}(Σₜ₌₁^{N}(xᵢ−x̅ᵢ)²+(yᵢ−y̅ᵢ)²), where (xᵢ, yᵢ) are the Cartesian coordinates of the vehicle 100 and refer to the reference trajectory.

f_{head} penalizes the differences between the obtained heading ψᵢ of the vehicle 100 from the kinematics propagation in equation (3) and the reference heading ψ̅₁ as f_{head}=w_{head}(Σᵢ₌₁^{N}(ψᵢ−ψ̅ᵢ)).

f_{col} applies a significant penalty if certain safety metrics are violated. To better avoid other vehicles during lane merging, two strategies are employed. The first strategy involves assigning a high-cost value to any steering angle solution that could lead to a collision, which is represented by the f_{col}. This approach ensures such a particle remains a less favorable choice in comparison to other particle candidates. Furthermore, the particle velocity is elevated when investigating steering angle solutions with high collision risks, thereby improving the exploration capacities. Briefly, violations of the safety metrics are determined based on an estimated proximity of the vehicle 100 and any of the other vehicles in the environment surrounding.

To integrate dimensions of the vehicle 100, the vehicle 100 and the other vehicles around the vehicle 100 are modeled using three circles. The metric for inter-vehicle distance hᵢ(x, y) between the vehicle 100 and the i-th vehicle (another vehicle), is determined by evaluating the smallest distance between any pair of the evaluation points. Formally, this is given by the following equation:

$${h}_{i} ( x , y ) = {min}_{p , q ∈ \{ - 1 , 0 , 1 \}} {d}_{i} ( p , q , x , y , ψ ) \qquad ( 11 )$$

where dᵢ(p, q, x, y, ψ)=[((x+pD cos ψ)−(xᵢ+qDᵢ cos ψi))²+((y+pD sin ψ)−(yᵢ+qDᵢ sin ψi))²]^{1/2}−(w+wᵢ), D=l−w, Dᵢ=lᵢ−wᵢ, l and w are the half-length and half-width of the vehicle 100, respectively, while lᵢ and wᵢ are the half-length and half-width of the i-th vehicle.

To identify evaluation points on the vehicle 100 using geometry according to equation (11), the heading angle ψ of the vehicle and heading angle of i-th vehicle ψᵢ are approximated utilizing finite differences between two adjacent points on their state trajectories. It is noted that the distance measures hᵢ(x, y) are made by employing the predicted positions of other vehicles with respect to the trajectory of the vehicle 100 using the environment estimation section 132 and the SGAN model.

To ensure collision-free trajectories relative to other vehicles, a safety specification is defined as hᵢ(x, y)≥ϵ, where ϵ is a user-defined present and/or predetermined safety buffer. The safety check is executed between the vehicle 100 and all surrounding vehicles. If any safety check violates the safety specification, the collision penalty term f_{col} is invoked to significantly raise the cost value of the subject particle.

Evaluating the interactive behavior of surrounding vehicles with respect to the future action of the vehicle 100 facilitates successful maneuvering in dense traffic. This interaction is addressed by the integration of the SGAN model in the PSO algorithm search in a two-way manner. The SGAN model iteratively infers the future positions of other vehicles based on the particle position, which may be used to predict the future position of the vehicle 100. On the other hand, the interactive behavior modeling capacities of the SGAN model are beneficial in updating the quality measure of particles and guiding the search process of the PSO algorithm. The safety constraints imposed in the PSO algorithm modify the cost values of particles, and the particle positions are then updated in the modified potential field based on the updated predictions of surrounding vehicles by the SGAN model.

fₐ, fⱼ, and fₛ are driving comfort metrics that capture smoothness of acceleration, jerk, and steering effort, respectively. fₐ and fⱼ are computed using finite differences over adjacent state trajectory points as follows:

$${f}_{a} = \text{?} {w}_{a} [ {\sum }_{i = 1}^{N - 2} {( {x}_{i + 2} - 2 {x}_{i + 1} + {x}_{i} / Δ {t}^{2} )}^{2} + {( {y}_{i + 2} - 2 {y}_{i + 1} + {y}_{i} / Δ {t}^{2} )}^{2} ] \qquad ( 12 )$$

$${f}_{j} = \text{?} {w}_{j} [ {\sum }_{i = 1}^{N - 3} {( - {x}_{i + 3} + 3 {x}_{i + 2} - 3 {x}_{i + 1} + {x}_{i} / Δ {t}^{3} )}^{2} + {( - {y}_{i + 3} + 3 {y}_{i + 2} - 3 {y}_{i + 1} + {y}_{i} / Δ {t}^{3} )}^{2} ] . \qquad ( 13 )$$

$$\text{?} \text{indicates text missing or illegible when filed}$$

Furthermore, the fₛ term is designed to regulate the steering effort in the form of fₛ=w̅ₛΣᵢ₌₁^{N}|δ̅ᵢ|².

fₗₐ is used to ensure proper alignment with the lane center as the horizon concludes. fₗₐ is represented as fₗₐ:=wₗₐ|y_{N}−y_{c}|, where y_{c} represents the vertical coordinate of the target lane center. Additionally, any particle that generates a state trajectory that violates the target lane's boundaries at the horizon's end incurs a penalty.

As described above, the PSO algorithm generates the dynamically feasible trajectory by propagating the best-found particles. Stated alternatively, the particle having a minimum cost value may be used to determine and generate the dynamically feasible trajectory.

Once the dynamically feasible trajectory is generated, a polynomial curve κ(l) is fit to the dynamically feasible trajectory (S40) using the fit section 136, so as to pass through points from the dynamically feasible trajectory [(\hat{x}ᵢ, ŷᵢ)]_{i=1:N}. The fitted polynomial curve κ(l) is then converted into reference waypoints (S50) using the conversion section 138. The reference waypoints converted by the conversion section 138 are then communicated to the trajectory generation section 130 for generation of the trajectory based on the communicated reference waypoints (S60).

The polynomial curve κ(l) with waypoint enforcement preserves the trajectory smoothness. Subsequently, refined waypoints are established by associating Cartesian coordinates from κ(l) with vehicle velocity profiles using existing motion/path planners. These waypoints then serve as reference positions and guide the iterative PSO procedure. The trajectory planning algorithm terminates once a feasible, collision-free trajectory with minimal cost is determined.

Inasmuch as the method may terminate, it is notable that the method is continuously repeated and updated, to account for changing dynamics. For example, changing or unexpected behavior by other vehicles, changing road conditions (e.g., rain, snow, or other factors that may affect a coefficient of friction or normal driving), or changing desires of the occupant(s) of the vehicle 100 (e.g., if the occupant(s) decides on a new destination).

The above method allows for the generation of the trajectory for control of the vehicle 100, which is then used to control the autonomous driving of the vehicle 100 by the vehicle actuator system 104. As noted above, the trajectory generated by the method shown in FIG. 4 is then sent to the control signal generator 140 which generates control signals related to controlling the vehicle 100 for autonomous driving, and the control signals are then transmitted to the vehicle actuator system 104 for control via the control signal transmitter 142. The actuators of the vehicle actuator system 104 are thereby controlled to cause the vehicle 100 to follow the generated trajectory in an autonomous driving mode.

It is to be appreciated that various modifications may be made to the above while remaining within the scope of the present application. For example, the cost function may be modified to consider additional or fewer factors.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method for generating and controlling a trajectory of an autonomous vehicle, comprising:
generating an initial trajectory of the autonomous vehicle;
estimating future positions of other vehicles in an environment surrounding the autonomous vehicle using a trained neural network model;
generating a dynamically feasible trajectory based on the initial trajectory and the estimated future positions of the other vehicles using a particle swarm optimization algorithm;
fitting a polynomial curve to the dynamically feasible trajectory; and
converting the polynomial curve into reference waypoints and generating the trajectory based on the reference waypoints.

2. The method according to claim 1, wherein generating the dynamically feasible trajectory using the particle swarm optimization algorithm comprises, in sequence:
uniformly randomly initializing a steering angle sequence and a velocity for each of a plurality of particles, wherein the steering angle sequence and the velocity of each of the plurality of particles are uniformly randomly initialized in a range determined based on reference waypoints derived from the initial trajectory;
iteratively updating the velocity, the steering angle sequence, and a position for each of the plurality of particles; and
calculating a cost value for each of the plurality of particles at each iteration of updating using a cost function.

3. The method according to claim 2, wherein the dynamically feasible trajectory is generated based on a particle among the plurality of particles having a minimum cost value.

4. The method according to claim 2, wherein the cost function is set to penalize deviations from a current trajectory, penalize deviations from a current heading, penalize violations of safety metrics, reward increases in driving comfort, and reward maintenance of a lane-center position.

5. The method according to claim 4, wherein the violations of safety metrics are determined based on an estimated proximity of the autonomous vehicle and any of the other vehicles in the environment surrounding the autonomous vehicle.

6. The method according to claim 1, wherein generating the dynamically feasible trajectory using the particle swarm optimization algorithm comprises:
for each of a plurality of particles, calculating a cost value using a cost function; and
selecting, as the dynamically feasible trajectory, a particle among the plurality of particles which has a minimum cost value.

7. The method according to claim 6, wherein the cost function is set to penalize deviations from a current trajectory, penalize deviations from a current heading, penalize violations of safety metrics, reward increases in driving comfort, and reward maintenance of a lane-center position.

8. The method according to claim 7, wherein the violations of safety metrics are determined based on an estimated proximity of the autonomous vehicle and any of the other vehicles in the environment surrounding the autonomous vehicle.

9. The method according to claim 2, wherein
generating the dynamically feasible trajectory using the particle swarm optimization algorithm further comprises evaluating the cost value for each of the plurality of particles against cost values for each of the plurality of particles calculated at prior iterations, and
iteratively updating the velocity, the steering angle sequence, and the position for each of the plurality of particles includes updating the velocity and the position based on at least one of a minimum cost value calculated at all prior iterations for each of the plurality of particles and a minimum cost value calculated at all prior iterations for all of the plurality of particles.

10. The method according to claim 9, wherein the cost function is set to penalize deviations from a current trajectory, penalize deviations from a current heading, penalize violations of safety metrics, reward increases in driving comfort, and reward maintenance of a lane-center position.

11. The method according to claim 10, wherein the violations of safety metrics are determined based on an estimated proximity of the autonomous vehicle and any of the other vehicles in the environment surrounding the autonomous vehicle.

12. The method according to claim 1, further comprising:
controlling actuators of the autonomous vehicle to cause the autonomous vehicle to follow the trajectory.

13. A vehicle control system provided in a vehicle, comprising a vehicle electronic control unit in communication with a vehicle sensor system and a vehicle actuator system, the electronic control unit being programmed to:
generate an initial trajectory of the vehicle for autonomously driving the vehicle;
estimate, based on received sensor data from the vehicle sensor system, future positions of other vehicles in an environment surrounding the vehicle using a trained neural network model;
generate a dynamically feasible trajectory based on the initial trajectory and the estimated future positions of the other vehicles using a particle swarm optimization algorithm;
fit a polynomial curve to the dynamically feasible trajectory;
convert the polynomial curve into reference waypoints and generating the trajectory based on the reference waypoints; and
transmit control signals to the vehicle actuator system to cause the vehicle actuator system to autonomously control the vehicle to travel according to the trajectory.

14. The vehicle control system according to claim 13, wherein the electronic control unit is programmed to, in generating the dynamically feasible trajectory:
uniformly randomly initialize a steering angle sequence and a velocity for each of a plurality of particles, wherein the steering angle sequence and the velocity of each of the plurality of particles are uniformly randomly initialized in a range determined based on reference waypoints derived from the initial trajectory;
iteratively update the velocity, the steering angle sequence, and a position for each of the plurality of particles; and
calculate a cost value for each of the plurality of particles at each iteration of updating using a cost function.

15. The vehicle control system according to claim 14, wherein the dynamically feasible trajectory is generated based on a particle among the plurality of particles having a minimum cost value.

16. The vehicle control system according to claim 14, wherein the cost function is set to penalize deviations from a current trajectory, penalize deviations from a current heading, penalize violations of safety metrics, reward increases in driving comfort, and reward maintenance of a lane-center position.

17. The vehicle control system according to claim 16, wherein the violations of safety metrics are determined based on an estimated proximity of the vehicle and any of the other vehicles in the environment surrounding the vehicle.

18. The vehicle control system according to claim 14, wherein the electronic control unit is programmed to:
in generating the dynamically feasible trajectory, evaluate the cost value for each of the plurality of particles against cost values for each of the plurality of particles calculated at prior iterations, and
in iteratively updating the velocity, the steering angle sequence, and the position for each of the plurality of particles, update the velocity and the position based on at least one of a minimum cost value calculated at all prior iterations for each of the plurality of particles and a minimum cost value calculated at all prior iterations for all of the plurality of particles.

19. The vehicle control system according to claim 13, wherein the electronic control unit is programmed to, in generating the dynamically feasible trajectory:
for each of a plurality of particles, calculate a cost value using a cost function; and
select, as the dynamically feasible trajectory, a particle among the plurality of particles which has a minimum cost value.

20. A vehicle capable of autonomous driving, comprising:
a vehicle sensor system;
a vehicle actuator system; and
a vehicle electronic control unit in communication with the vehicle sensor system and the vehicle actuator system, the electronic control unit being programmed to:
generate an initial trajectory of the vehicle for autonomously driving the vehicle;
estimate, based on received sensor data from the vehicle sensor system, future positions of other vehicles in an environment surrounding the vehicle using a trained neural network model;
generate a dynamically feasible trajectory based on the initial trajectory and the estimated future positions of the other vehicles using a particle swarm optimization algorithm;
fit a polynomial curve to the dynamically feasible trajectory;
convert the polynomial curve into reference waypoints and generating the trajectory based on the reference waypoints; and
transmit control signals to the vehicle actuator system to cause the vehicle actuator system to control the vehicle to travel according to the trajectory, and
the vehicle actuator system being configured to drive the vehicle based on the control signals transmitted by the electronic control unit.
